(19) United States
(12) Patent Application Publication
(10) Pub. No.: US 2013/0305388 A1
(43) Pub. Date: Nov. 14, 2013

(54) LINK STATUS BASED CONTENT PROTECTION BUFFERS

(71) Applicant: QUALCOMM INCORPORATED, San Diego, CA (US)

(72) Inventors: Sudeep Ravi Kottilingal, San Diego, CA (US); Christian Josef Wiesner, Uxbridge (CA); Dafna Shaool, Binyamina (IL); Jeffrey David Shabel, San Diego, CA (US)

(73) Assignee: QUALCOMM INCORPORATED, San Diego, CA (US)

(21) Appl. No.: 13/842,839

(22) Filed: Mar. 15, 2013

Related U.S. Application Data
(60) Provisional application No. 61/645,540, filed on May 10, 2012.
(60) Provisional application No. 61/645,585, filed on May 10, 2012.

(51) Int. Cl. G06F 21/62

(52) U.S. Cl. CPC G06F 21/6218
USPC 726/28

(57) ABSTRACT

Systems, methods, and devices for processing video data are disclosed. Some examples include a content receiver including an unsecure processor and an unsecure memory coupled to the unsecure processor. The example includes content protection zone hardware including a secure memory and an input for receiving content. The input coupled to the content protection zone hardware, wherein the content protection zone hardware determines if the received content is secure or unsecure and directs secure content to the secure memory and unsecure content to the unsecure memory.

This application claims the benefit of:

U.S. Provisional Application No. 61/645,540, filed May 10, 2012 and

U.S. Provisional Application No. 61/645,585, filed May 10, 2012,

the entire content each of which is incorporated herein by reference.

### TECHNICAL FIELD

This disclosure relates to content data flow, and more particularly, to protection mechanisms for data.

### BACKGROUND

Various systems and devices may access content via, e.g., High-Definition Multimedia Interface (HDMI)/component or broadcast modem channels. The content may include both protected content and non-protected content. Protected content may include content that is not accessible by a processor or other device that may be unsecure. An unsecure processor or other such unsecure device may be a device that may be more susceptible to manipulation. For example, an unsecure processor may be a processor that executes code that may be changed by a hacker or other individual with malicious intent. Non-protected content may include content that is accessible by a processor or other device that may be unsecure. Additionally, the content may be video, audio, some combination of both, or other forms of content. The incoming content may be handled by unsecured or non-secure hardware, unsecured or non-secure software, or some combination of secured or non-secured hardware and software. In examples including unsecured software or other non-secure software the unsecured or non-secure software may be hacked or otherwise tampered with which may allow unauthorized access to the protected content.

### SUMMARY

This disclosure relates to content data flow, and more particularly, to protection mechanisms for data. In some examples, data may be protected by using mechanisms that deny access to the data by a processor or other device that may be unsecure. For example, these mechanisms may deny access to such data by processor that execute software code that may be changed by a hacker or other individual with malicious intent. This may be done, for example, by not allowing such unsecure processors to have access to a memory or memory addresses that are secure. Secure memory or secure memory locations may, for example, be memory or memory locations that are protected from access by certain processors in a device, e.g., unsecure processors. This may be done by, for example, using hardware that monitors reads or writes within the device and denies access to the memory by the unsecure processors.

In one example, this disclosure proposes a content receiver including an unsecure processor and an unsecure memory coupled to the unsecure processor. The unsecure memory stores unsecure code such as open source code. The content receiver further includes an input for receiving content. The input is coupled to content protection zone hardware, software, or both, which includes a secure memory. Additionally, the content protection zone determines if the received content is secure or unsecure and directs secure content to the secure memory and unsecure content to the unsecure memory.

In one example, the disclosure describes a method that includes receiving content at an input coupled to a content protection zone software executing on a device including an unsecure processor and an unsecure memory coupled to the unsecure processor, determining if the content is secure or unsecure, and storing the content in a secure memory when the content is secure and storing the content in the unsecure memory when the content is unsecure.

In another example, the disclosure describes a device that includes a content receiver including an unsecure processor, an unsecure memory coupled to the unsecure processor, content protection zone including a secure memory, and an input for receiving content, the input coupled to the content protection zone hardware, wherein the content protection zone hardware determines if the received content is secure or unsecure and directs secure content to the secure memory and unsecure content to the unsecure memory.

In another example, the disclosure describes an integrated circuit (IC) including an unsecure processor, an unsecure memory coupled to the unsecure processor, and an input for receiving content, the input coupled to a content protection zone hardware, the content protection zone hardware including a secure memory, wherein the content protection zone hardware determines if the received content is secure or unsecure and directs secure content to the secure memory and unsecure content to the unsecure memory.

In another example, the disclosure described a content receiver including an unsecure processor, an unsecure memory coupled to the unsecure processor, and means for receiving content coupled to means for providing a content protection zone, the means for providing the content protection zone including a secure memory, means for determines if the received content is secure or unsecure and means for directing secure content to the secure memory and unsecure content to the unsecure memory.

In another example, the disclosure describes a computer-readable storage medium. The computer-readable storage medium having stored thereon instructions that upon execution cause one or more processors of a device to receive content at an input coupled to a content protection zone of the device, at least one of the processors of the device including an unsecure processor, the device further including an unsecure memory coupled to the unsecure processor, determine if the content is secure or unsecure, and store the content in a secure memory when the content is secure and storing the content in the unsecure memory when the content is unsecure.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a device that may be configured to implement one or more aspects of this disclosure.

FIG. 2 is a block diagram illustrating an example data flow of a content protection system.

FIG. 3 is a block diagram illustrating an example of a device that may be configured to implement one or more aspects of this disclosure.

FIG. 4 is a flow diagram illustrating aspects of an example content protection zone policing block configured to implement one or more aspects of this disclosure.

FIG. 5 is a flow diagram illustrating an example method implementing one or more aspects of this disclosure.

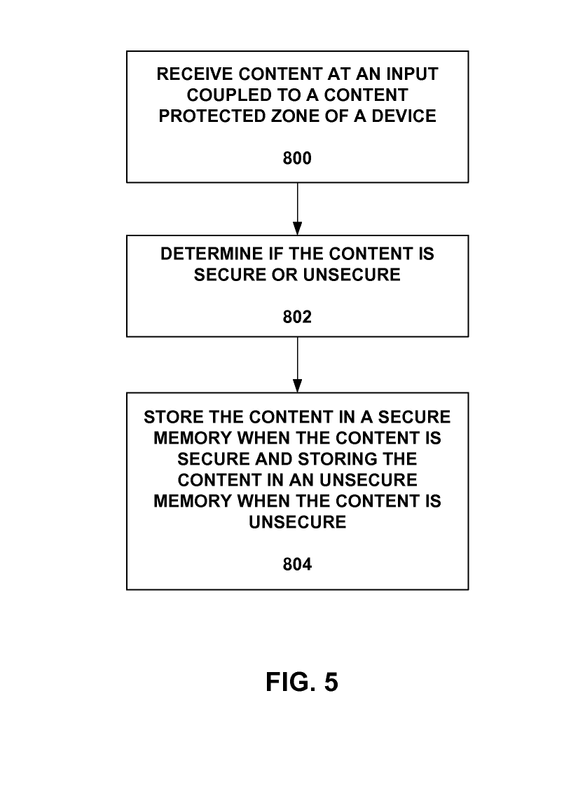

### DETAILED DESCRIPTION

This disclosure relates to content data flow, and more particularly, to protection mechanisms for data. Some systems or devices may process content that might need to be protected from unauthorized access. These systems or devices may include unsecure processors or other unsecure hardware. For example, the unsecure hardware (e.g., unsecure processor) may be a hardware that may be manipulated by people such as hackers or other individual with malicious intent. For example, the hacker may wish to have access to the content being processed by the systems or devices even if the hacker does not have any rights to the content.

In one example, the content may be copyrighted. This content might be available to those who purchase the content. The hacker may attempt to access this content without actually purchasing the content.

In some examples, data may be protected by using mechanisms that deny access to the data by a processor or other device that may be unsecure. For example, these mechanisms may deny access to such data by processor that execute software code that may be changed by a hacker or other individual with malicious intent. This may be done, for example, by not allowing such unsecure processors to have access to a memory or memory addresses that are secure. Secure memory or secure memory locations may, for example, be memory or memory locations that are protected from access by certain processors in a device, e.g., unsecure processors. This may be done by, for example, using hardware that monitors reads or writes within the device and denies access to the memory by the unsecure processors.

One example of the disclosure includes link status based content protection buffers. For example, the content protection buffers may be used based on the link status. For example, when the link status indicates that the link is receiving secure data, the content protection buffers are used.

In one example, the disclosure describes hardware for processing secure received data, such as secure video, secure audio, both, or any other secure content. The hardware for processing secure data is separate from hardware for processing unsecured data, such as unsecure video, unsecure audio, or both. The hardware for processing unsecure data may include a processor executing non-secure code, while the hardware for processing secure data may include a processor executing secure code. Secure data can include data that is encrypted or otherwise protected to, for example, eliminate or lower the probability of copying, unauthorized access, etc.

Some examples provide a full hardware solution that assumes no trusted firmware is running on a picture processing unit (PPU). One example may have two contexts: secure and non-secure. In some examples, a binary “0” is defined as non-secure and a binary “1” is defined as secure. In some examples, one content protection bit may be used per read port programmed by a non-secure software driver. Hardware may drive content protection bits for all write ports. In an example, a trusted control unit may allocate buffers and designate each as being secure or non-secure. A device may then receive the addresses to all of its required buffers, such that it may read and write protected content to protected buffers and unprotected content to unprotected buffers.

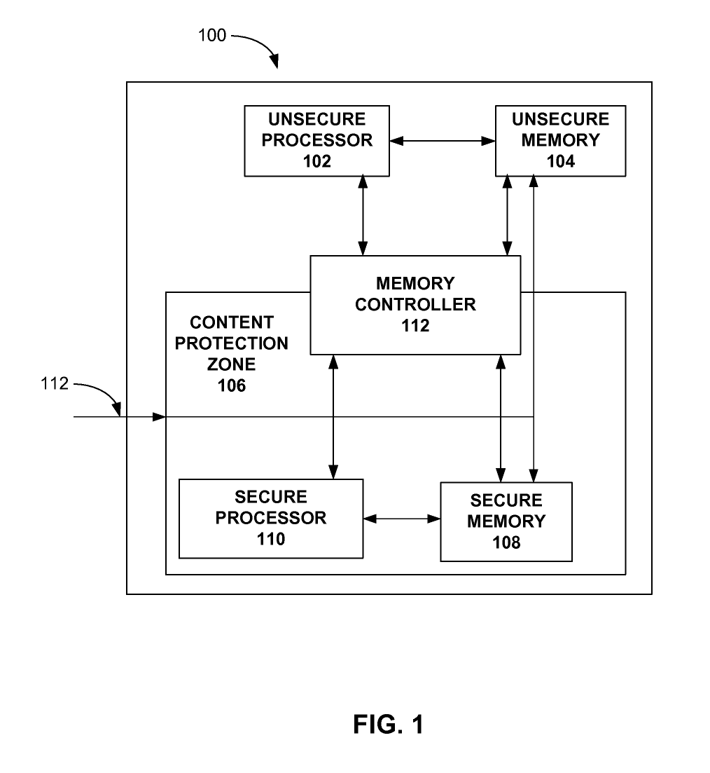

FIG. 1 is a block diagram illustrating an example of device 100 that may be configured to implement one or more aspects of this disclosure. In an example, device 100 can be a content receiver that includes unsecure processor 102. Unsecure processor 102 is coupled to unsecure memory 104 that stores unsecure code. For example, unsecure memory 104 may store unsecure code, or other types of code that may be considered unsecure, and more susceptible to alteration by others. Additionally, unsecure memory 104 may store unsecure content, such as content that is not encrypted or copy protected.

An input 112 for receiving content is coupled to the content protection zone hardware 106. Input 112 may be, for example, High-Definition Multimedia Interface (HDMI), component video, digital broadcast, or any other type of input configured to receive video, audio and/or graphics content. In various examples, the content may include audio, video, or some combination of audio and video. Additionally, the content protection zone hardware 106 includes secure memory 108.

In some examples VGA signals are not treated as protected. Protected material will generally never leave the content protection zone, at least until the output is displayed. In some examples, audio is not required to be under the content protection zone. In some examples, some content types may cross domains (e.g., move from CPZ to non-protected) under certain rules and verifications that may be set up to allow for the content to be protected from inadvertent release.

The content protection zone hardware 106 determines if the received content is secure or unsecure. In an example, this may be done by a memory management unit (MMU). For example, content protection zone hardware 106 (e.g., through memory controller 112 or other hardware) may determine if the content is secure or unsecure based on a determination that at least a portion of the content is encrypted or based on a secure syntax element flag that indicates that the content is secure. In an example, content protection zone hardware 106 directs secure content to secure memory 108 and unsecure content to unsecure memory 104.

The unsecure processor 102, which is executing instructions that may be unsecure code, such as open source code, cannot access secure memory 108. Accordingly, unsecure processor 102 cannot access protected content that is received.

In an example, content protection zone 106 may include secure processor 110 executing secure code stored in secure memory 108. In other examples, however, content protection zone 106 may be implemented in fixed-function hardware or other programmable hardware. In some examples, content protection zone 106 may be hardware, software, firmware, or some combination of these. For example, content protection zone 106 may include hardware executing secure software to implement the functionality described herein.

Unsecure memory 104 and secure memory 108 may, in some examples, be a single memory with one or more secure address rejoins and one or more unsecure address regions. The secure address regions may be protected from unauthorized access by unsecure processor 102. The unsecure address regions may be accessible by unsecure processor 102. Device 100 may include memory controller 112 that enforces the secure and unsecure address regions. This keeps processor 102 from accessing secure memory 108. For example, if unsecure processor 102 attempts to read from secure memory 108, memory controller 112 may block the read.

In some examples, memory read or write requests may be tagged with information relating to what hardware block, e.g., unsecure processor 102 or secure processor 110 is making the request. Memory controller 112 may receive read and write requests and the tag information relating to what hardware block is making the request.

An example device that may be configured to implement one or more aspects of this disclosure may be implemented as an integrated circuit (IC). Thus, such an IC can include unsecure processor 102 and unsecure memory 104 coupled to unsecure processor 102. Unsecure memory 104 on the IC can store unsecure code and unsecure instructions for the processor. An input to the IC for receiving content is coupled to the content protection zone hardware 106 implemented on the IC which includes secure memory 108. The IC may also include the hardware to determine if the received content is secure or unsecure, e.g., as part of content protection zone hardware 106. This hardware may direct secure content to secure memory 108 and unsecure content to unsecure memory 104.

As illustrated in FIG. 1, in an example, device 100 may include content protection aware intellectual property (IP) cores, such as secure processor 110. Additionally, other processing capability may also be provided, e.g., unsecure processor 102 or other secure or unsecure processors. In some examples, a single processor with secure and unsecure modes may be used in place of secure processor 110 and unsecure processor 102. In other words, secure processor 110 and unsecure processor 102 may be a single processor that switches between a secure and an unsecure mode or processes both secure and unsecure data. In a secure mode or when processing secure data the data might only be written to secure memory 108. Conversely, in an unsecure mode or when processing unsecure data the data might only be written to unsecure memory 104. It may be possible to write unsecure content to secure memory. This content would generally then be protected or secure content. For example, when secure content and unsecure content are mixed it may be necessary to protect this content. Additionally, it will be understood that the secure memory 108 and unsecure memory 104 may be a single memory and various addresses of the memory may be secure while other addresses of the memory may be unprotected. For example, in some cases hardware external to a single processor in a single processor implementation keeps track of addresses where reads and writes occur so that the processor cannot write protected content to unsecure memory 104. In some examples, unsecure processor 104 may be a processor operating in an unsecure mode and secure processor 108 may be the same processor operating in a secure mode.

Content protection hardware may also include a Secure Execution Environment (SEE). The SEE may include cryptographic functionalities, access control management, secure boot etc. In some examples, cryptographic functionality may include keys, access control, content decryption, and content encryption.

In some examples, a content receiver includes unsecure processor 102 and unsecure memory 104 coupled to unsecure processor 102. Unsecure memory 104 may store unsecure code. Content protection zone 106 may include secure memory 106. Input 112 may be used for receiving content. Input 112 may be coupled to content protection zone 106. Content protection zone 106 determines if the received content is secure or unsecure and directs secure content to secure memory 108 and unsecure content to unsecure memory 104. In some examples, unsecure processor 108 may include a microprocessor processor and the unsecure code may include open-source code. Content protection zone 106 may include a second processor (e.g., secure processor 110) executing secure code stored in secure memory 108. Unsecure processor 104 generally cannot access the secure memory.

In some examples, the content comprises audio and video. Video may be protected in some examples. Audio may be protected in other examples. In some examples, both audio and video may be protected.

In some examples, determining if the content is secure or unsecure includes determining if at least a portion of the content is encrypted. For example, encrypted data may not need protection, since it is encrypted, which already provides protection from unauthorized access. In an example, determining if the content is secure or unsecure includes making a determination based on a syntax element indicating if the content is secure or unsecure.

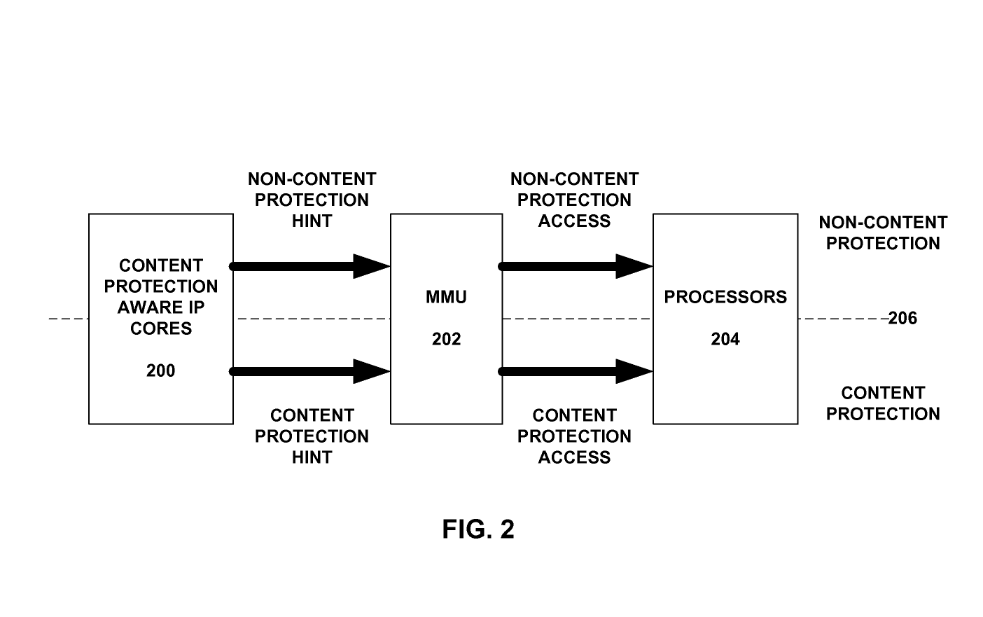

FIG. 2 is a block diagram illustrating an example data flow of a content protection system according to examples of this disclosure. As illustrated in the block diagram, the content protection system may include content protection aware intellectual property (IP) cores 200, MMU 202, and processor 204. MMU 202. Processors 204 may include unsecure processor 102 and secure processor 110. As indicated by dotted line 206, the data flow may be split into non-content protection and content protection. In some example systems, the system can concurrently support both protected and unprotected content. Protected data generally cannot flow from the content protection side to the non-content protection side. This may include data flows within the block for processors 204 as well as blocks 200 and 202. In FIG. 2 the data flow is generally from left to right as indicated by the arrows.

As illustrated in FIG. 2, generally protected content does not cross to the non-protected content area. It may also generally be true that non-protected content does not cross to a protected content area. In some examples, however, domain crossing will happen under specific rules and validations that may be established. Non-protected content written to the protected content area will generally not be available to a non-protected processor because this data will now be protected.

In an example, content protection zone (CPZ) aware or content protection aware IP cores 200 may provide a coded bit, coded bits, or coded signal, that indicates if content is non-protected. The coded bit(s) or coded signal may be a signal that provides an indication if data is protected or not protected. Because software in the non-content protection side may be unsecure and may be accessed by un-trusted programmers, however, the system may attempt to verify the coded bit(s) or coded signal. Systems implementing examples of this disclosure may verify rather than rely on the coded bit or coded signal for the information regarding protected and unprotected content because the software generating the coded bit(s) or coded signal may, in some cases, be compromised. Accordingly, the coded signal or coded bit(s) may not be accurate and may be an incorrect result based on the operation of software generated by un-trusted programers. In an example, the coded bit or coded signal may be based on a state of the content, for example, if the content is encrypted. This may be an indication that the content is secure content. If, on the other hand, the content is unencrypted, this may indicate that the content is unsecure content. For example, the CPZ aware cores may provide an indication to the MMU whether the content should be placed in protected memory or not. The decision of how to set the indicators is based on CPZ policies. CPZ policies may instruct that content which was decrypted may be protected, depending on the content type

Ultimately, determining if content is secured or unsecured may be based on where the content enters the system. Content coming into the system through a secure input should always be secured. In other words, it should never be written to an unsecure memory or an unsecure memory location. For example, some HDMI, component video, Additionally, in some examples, content coming into the system through an unsecure input may generally remain unsecure. In some examples, however, it may be possible for unsecure content to cross into a secure zone. This is because no loss of secure content will occur if unsecure content is written to a secure area. In some examples, however, this may not be allowed, since unsecure content written to the secure side of the system will no longer be available to the unsecure processor. Accordingly, processing may need to be performed by the secure processor, which may decrease processing cycles for use to process secure content.

In an example, hardware that is independent of any unsecure software may control access to protected content. For example, MMU 202 may receive coded bits indicating if content is protected or non-protected, however, content may be passed to processor 204 based on the source of the content, protected or non-protected, rather than the coded bit received.

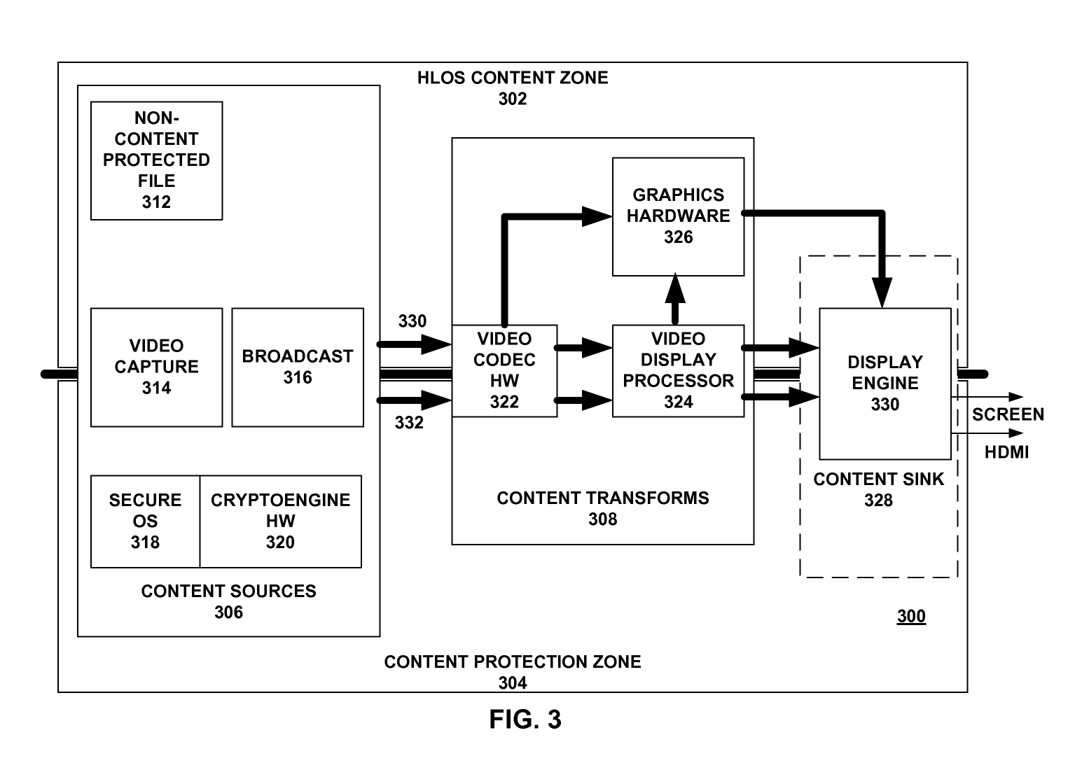

FIG. 3 is a block diagram illustrating example device 300 that may be configured to implement one or more aspects of this disclosure. Device 300 may be divided into High-level Operating System (HLOS) content zone 302 and content protection zone 304. In the HLOS content zone content is generally not protected. In some cases, it may be possible for software running on a processor in this zone to be hacked. For example, this software may be unsecure software that might be accessible and editable by a wide range of people or organizations. Accordingly, it may be useful to restrict the access of processors executing such software such that these processors do not have access to certain content that may be protected. In some examples, the content to be protected may be copyrighted. In some cases, a person or organization may attempt to access such content by using unsecure software running on processors within device 300. For example, by hacking the unsecure software. It may be possible to decrease or eliminate unintended release of copyrighted material by keeping processing of copyrighted material separate from processors executing unsecure code.

In content protection zone 304, the content is generally protected. In some examples, the content is always protected. In the illustrated example, data from content protection zone 304 never leaves the protected area, except for display on a screen. Content protection zone 304 may encapsulate CPZ aware functional blocks that may be within device 300. The CPZ may process data separate from any processing done by processors running unsecure code, for example. In this way, the data processed in content protection zone 304 may be protected from inadvertent copying by, for example, using unsecure software running on a processor or processors running in HLOS content zone 302 to read the data and writing the data out over a communication channel.

In the illustrated example, content sources 306 may include non-content protection file 312 such as a non-content protected file or stream, or input from a camera, e.g., a local camera connected to device 300. This material may not need to be protected. In other words, the material might not need to be encrypted or otherwise protected. For example, the material might not be copyrighted or might not be commercially valuable, such that it would be sought after by larger numbers of people. Accordingly, it may not be necessary to protect such data.

Another example content source 306 includes video capture port 314, such as one or more HDMI inputs, other digital inputs, analog inputs, optical inputs, Ethernet inputs, wireless inputs, or any other wired or wireless input for content. In some examples, content input through video capture 314 may be protected. In other examples, content input through video capture 314 may not be protected. This is illustrated in FIG. 3, in which video capture 314 spans an area including both HLOS content zone 302 and content protection zone 316.

Another example content source 306 may include content received through broadcast 316. In some examples, signals may be received over the air (i.e., through a wireless connection). Those signals may or may not be encrypted. In some examples, broadcast 316 data may be protected. In other examples, broadcast 316 data may not be protected. This is also illustrated in FIG. 3, in which broadcast 316 spans an area including both HLOS content zone 302 and content protection zone 304.

Secure OS 318 may process protected content. In one example, secure OS 318 may be a TRUSTZONE. TRUSTZONE is an example of a secureOS, such as secureOS 318 of FIG. 3 and is available from Arm Holdings. In some examples, the TRUSTZONE may be part of the CPZ. In some examples, the secureOS, e.g., TRUSTZONE may be executed by a secure processor that may be part of content sources 306. The secure processor may also be a virtual processor and not a physical one.

This data may flow through crypto-engine hardware 320. After data from secure OS 318, is decrypted by crypto-engine hardware 320 it may be protected in content protection zone 304. In other words, the decrypted content may be kept separate from processors in HLOS content zone 302 such that these processors are not allowed to access the data that is to be protected. For example, graphics hardware may not have access to any protected content. In some examples, this may be accomplished by restricting access to one or more memories or memory locations that may contain such protected content. As illustrated in FIG. 3, video codec hardware 322 and video display processor 324 may include some hardware within the HLOS content zone 302 and other hardware in content protection zone 304. To keep protected content separate from unprotected content these blocks may include, for example, separate hardware in within the HLOS content zone 302 and other hardware in content protection zone 304, such as one processor in within the HLOS content zone 302 and another processor in content protection zone 304.

The block diagram of FIG. 3 illustrates the protected content data flow. Content from content sources 306 may be input to content transforms 308 using either unprotected path 330 or protected path 332. Unprotected path 330 connects unprotected sources, e.g., non-content protected files 312 and unprotected video capture 314 and unprotected broadcast to content transforms 308 for further processing in an unprotected area. Protected path 332 connects protected sources, e.g., protected video capture 314 and protected broadcast, and secure OS 318 sources to content transforms 308 for further processing in a protected area.

As illustrated in FIG. 3, video codec hardware 322 and video display processor 324 span HLOS content zone 302 and content protection zone 304. Video codec hardware 322 and video display processor 324 may process both protected and unprotected content. In some examples, video display processor 324 may be a hardware accelerator. In some examples, video codec hardware 322 may comprise a single video codec that processes both protected and unprotected content. In other examples, video codec hardware 322 may comprise separate video codecs, one of which processes protected and another which processes unprotected content. Similarly, in some examples, video display processor 324 may comprise a single video display processor that processes both protected and unprotected content. In other examples, video display processor 324 may comprise separate video display processors, one of which processes protected and another which processes unprotected content. In such examples, the separate processors that process unprotected content may not have access to protected content. For example, these processors may be restricted from reading or writing memory regions that may contain protected content.

In some examples, graphics hardware 326 may be used to process unprotected content. In various examples, graphics hardware 326 may not have access to protected content. For example, graphics hardware 326 may be restricted from reading or writing memory regions that may contain protected content. In other examples, graphics hardware 326 may have access to both protected and unprotected content.

Content that enters content transform 308 as protected content 332 should remain protected. Accordingly, content that enters content transform 308 may be processed by video codec 322 and video processor 324 or protected portions of this hardware. This content may be read from and written to protected regions of memory, but not unprotected regions of memory. The state of the input content (protected or unprotected) will generally need to be known so that it may be processed correctly, either within content protection zone 304 if the content is protected or in HLOS content zone 302 if the content is not protected.

In the illustrated example, content transforms 308 includes video codec hardware 322, video display processor 324 and graphics processing unit 326. Display engine 330 may be a content sink 328 in some examples.

In some examples, in the event that protected data is inadvertently written to the unprotected data buffer(s) the hardware may generate a fault or violation.

Thus, in an example, a content protection zone may be provided. The content protection zone can receive both protected and unprotected content. The protected content may be contained within the content protection zone, while the unprotected content may be written to the HLOS content zone 302. In this way, protected content may be withheld from the HLOS content zone 302, while the HLOS can still be used to save and/or process non-protected content.

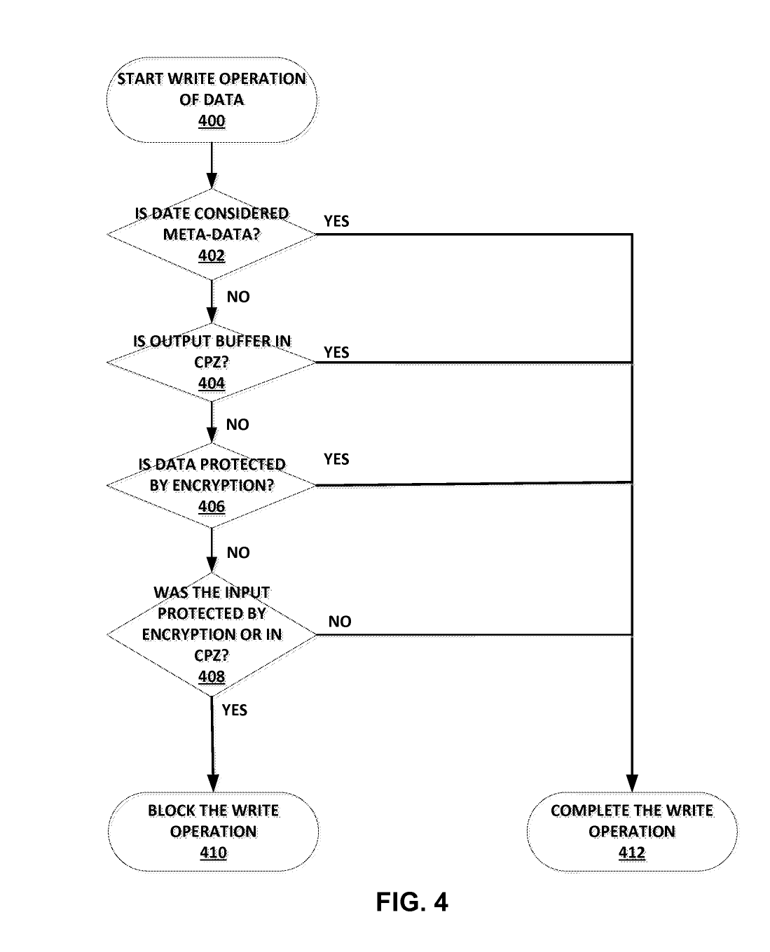

FIG. 4 is a block diagram illustrating an example content protection zone policing block configured to implement one or more aspects of this disclosure. The policing block may monitor the start of a data write operation (400). Policing block may block the write operation (410) or allow the write operation to be completed (512) based on a series of considerations. In the illustrated example, policing block completes the write operation (412) if the data is considered metadata (402). Metadata is data that may typically be associated with a multimedia buffer. The metadata may typically be associated as an appendix or header to the buffer. This can change with every packet. In some examples, meta-data may not need to be protected. For example, meta-data is generally not considered content that individuals or organizations will generally attempt to gain access to surreptitiously. Accordingly, a write of meta-data may be allowed even if the write is to a non-protected buffer.

If the data is not meta-data, in the illustrated example, policing block completes the write operation (412) if the output buffer is in the content protection zone (404). Content being written to buffers in the content protection zone will continue to be protected after the write occurs. Because this content will still be protected after the write occurs the write may be completed (412).

If the data is not meta-data and the output buffer is not in the content protection zone, in the illustrated example, policing block completes the write operation (412) if the data is protected by encryption (406). Content protected by encryption will continue to be protected after the write occurs. Even if the content is being written to an unprotected buffer or area of memory, it is encrypted and therefore protected from unauthorized access. Because of the encryption, this content will still be protected after the write occurs. Accordingly, the write may be completed (412).

If the data is not meta-data, the output buffer is not in the content protection zone, and the data is not protected by encryption, in the illustrated example, policing block blocks the write operation (510) if the data was previously protected by encryption and is in the output buffer is not in the protection zone (508). In some examples, if the input was protected by encryption or in CPZ and the output buffer is not in CPZ (504), then the operation is blocked. Policing block may determine that the output buffer is not in the content protection zone (504), accordingly, if the data was protected and in the content protection zone, then the write operation should be blocked (510). Content that was protected by encryption, e.g., decrypted content, will no longer be protected from unauthorized access if it is in a memory available to be read by an unsecure processor such as a processor running unsecure code if the content is written to an unsecure buffer or memory location. If the data was not protected or was not in the content protection zone, then the write operation should be completed (512).

Accordingly, FIG. 4 illustrates one example of aspects of various content that may be considered when determining if a write operation should be allowed or blocked. This may generally be applied to write operations performed, for example, by unsecure processor 102. This may keep data from being written to an unsecure memory or buffer location. In some examples, keeping unsecure processor 102 from reading from secure memory 108 will be much simpler. Policing block or other hardware or combination of hardware and trusted software may disallow all reads by unsecure processor 102 to any memory location that is in secure memory 108.

In an example, the systems and methods described herein may be provided for on an integrated circuit (IC). Such an IC may include an unsecure processor and an unsecure memory coupled to the unsecure processor. The unsecure memory may store unsecure code which may be executed by the unsecure processor. The IC may include an input for receiving content. The input may be coupled to a content protection zone hardware which may include a secure memory. The content protection zone hardware may further be configured to determine if the received content is secure or unsecure and directs secure content to the secure memory and unsecure content to the unsecure memory. The content protection zone hardware may include a second processor executing secure code stored in the secure memory. The unsecure processor cannot access the secure memory.

FIG. 8 is a flow diagram illustrating an example method implementing one or more aspects of this disclosure. Content protection zone hardware 106 receives content as input 112 coupled to a content protection zone of a device 100 (1000). Device 100 may include unsecure processor 102 and unsecure memory 104 coupled to unsecure processor 102. Additionally, unsecured memory 104 may store unsecure code.

Secure processor 110 may be part of content protection zone 106 may make a determination regarding if the content received at input 112 is secure or unsecure (1002). Secure processor 110 may determine if at least a portion of the content is encrypted, for example. Encrypted data may be considered secure in some examples. Unencrypted data may need further protection, e.g., by the content protection zone. In another example, secure processor 110 may check the state of a secure syntax element flag in the data to indicate if the data is secure or unsecure.

Secure processor 110 may cause the content to be stored in a secure memory 108 when the content is determined to be secure and in unsecure memory 104 when the content is determined to be unsecure (1004). The unsecure processor 102 may be configured and coupled in a way so that it cannot access the secure memory. Accordingly, the unsecure processor 102 cannot access secure content.

In an example, full resolution content is a protected stream. Additionally, in some examples, for levels of resolution below full resolution, sub-resolution, protection is also provided. Additionally, video firmware may also be protected as well as data from sensor, measurement results (e.g. Histogram, IFM Min/Max/SOD, Active Region Detect, etc.). In some examples, all resisters may be locked from access by processors in the HLOS content zone. Additionally, all metadata may be protected from access by processors in the HLOS content zone.

Some examples may provide for tracking of all protected inputs into the system. Such an example may include various data streams. An example may include an added secure interrupts from the data streams hardware change to block or restrict secure data out based on device specific policy.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored as one or more instructions or code on a computer-readable medium. Computer-readable media may include computer data storage media. Data storage media may be any available media that can be accessed by one or more computers or one or more processors to retrieve instructions, code and/or data structures for implementation of the techniques described in this disclosure. By way of example, and not limitation, such computer-readable media can comprise random access memory (RAM), read-only memory (ROM), EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (i.e., a chip set). Various components, modules or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A content receiver comprising:
an unsecure processor;
an unsecure memory coupled to the unsecure processor;
content protection zone including a secure memory; and
an input for receiving content, the input coupled to the content protection zone hardware, wherein the content protection zone hardware determines if the received content is secure or unsecure and directs secure content to the secure memory and unsecure content to the unsecure memory.

2. The content receiver, of claim 1, wherein the unsecure memory stores unsecure code.

3. The content receiver, of claim 2, wherein the unsecure processor comprises a microprocessor and the unsecure code comprises open-source code.

4. The content receiver of claim 1, wherein the content protection zone comprises a second processor executing secure code stored in the secure memory.

5. The content receiver of claim 1, wherein the content receiver is configured such that the unsecure processor cannot access the secure memory.

6. The content receiver of claim 1, wherein the content comprises audio and video.

7. The content receiver of claim 1, wherein the content protected hardware is further configured to determine if the content is secure or unsecure by determining if at least a portion of the content is encrypted and wherein content is protected by the content protection zone when the content is not encrypted.

8. The content receiver of claim 1, wherein the content protected hardware is further configured to determine if the content is secure or unsecure by making a determination based on a syntax element indicating if the content is secure or unsecure.

9. The content receiver of claim 1, further comprising a content protection zone policing block configured to block an input when an input buffer status indicates content protection, a software status indicates content protection is disabled, and a hardware status indicates content protection.

10. The content receiver of claim 1, further comprising a content protection zone policing block configured to indicate a valid secure transaction when an input buffer status indicates content protection, a software status indicates content protection is enabled, an output buffer status indicates content protection, and a hardware status indicates content protection.

11. The content receiver of claim 1, further comprising a content protection zone policing block configured to indicate a valid non-secure transaction when an input buffer status indicates no content protection, a software status indicates content protection is disabled, an output buffer status indicates no content protection, and a hardware status indicates no content protection.

12. The content receiver of claim 1, further comprising a content protection zone policing block configured to indicate an input page fault when an input buffer status indicates no content protection, a software status indicates content protection is enabled, an output buffer status indicates content protection, and a hardware status indicates content protection.

13. The content receiver of claim 1, further comprising a content protection zone policing block, the content protection zone policing block receiving a coded bit indicating the content should be protected.

14. The content receiver of claim 13, wherein the coded bit comprises a hardware bit indicator.

15. A method comprising:
receiving content at an input coupled to a content protection zone software executing on a device including an unsecure processor and an unsecure memory coupled to the unsecure processor;
determining if the content is secure or unsecure; and
storing the content in a secure memory when the content is secure and storing the content in the unsecure memory when the content is unsecure.

16. The method of claim 15, wherein the unsecure memory stores unsecure code.

17. The method of claim 16, wherein the unsecure processor comprises a microprocessor and the unsecure code comprises open-source code.

18. The method of claim 15, further comprising executing secure code stored in the secure memory on a second processor, the second processor and the secure memory comprising a protected zone hardware.

19. The method of claim 15, wherein the unsecure processor cannot access the secure memory.

20. The method of claim 15, wherein the content received comprises audio and video.

21. The method of claim 15, wherein determining if the content is secure or unsecure includes determining if at least a portion of the content is encrypted and wherein content is protected by the content protection zone when the content is not encrypted.

22. The method of claim 15, further comprising determining if the content is secure or unsecure based on a syntax element indicating if the content is secure or unsecure.

23. The method of claim 15, further comprising blocking an input when an input buffer status indicates content protection, a software status indicates content protection is disabled, and a hardware status indicates content protection.

24. The method of claim 15, further comprising indicating a valid secure transaction when an input buffer status indicates content protection, a software status indicates content protection is enabled, an output buffer status indicates content protection, and a hardware status indicates content protection.

25. The method of claim 15, further comprising indicating a valid non-secure transaction when an input buffer status indicates no content protection, a software status indicates content protection is disabled, an output buffer status indicates no content protection, and a hardware status indicates no content protection.

26. The method of claim 15, further comprising indicating an input page fault when an input buffer status indicates no content protection, a software status indicates content protection is enabled, an output buffer status indicates content protection, and a hardware status indicates content protection.

27. The method of claim 15, further comprising receiving a coded bit indicating the content should be protected.

28. The method of claim 15, wherein the coded bit comprises a hardware bit indicator.

29. An integrated circuit (IC) comprising:
an unsecure processor;
an unsecure memory coupled to the unsecure processor; and
an input for receiving content, the input coupled to a content protection zone hardware, the content protection zone hardware including a secure memory, wherein the content protection zone hardware determines if the received content is secure or unsecure and directs secure content to the secure memory and unsecure content to the unsecure memory.

30. The IC of claim 29, wherein the unsecure memory stores unsecure code.

31. The IC of claim 29, wherein the content protection zone hardware comprises a second processor executing secure code stored in the secure memory.

32. The IC of claim 29, wherein the content receiver is configured such that the unsecure processor cannot access the secure memory.

33. The IC of claim 29, wherein the content comprises audio and video.

34. The IC of claim 29, wherein the content protected hardware is further configured to determine if the content is secure or unsecure by determining if at least a portion of the content is encrypted and wherein content is protected by the content protection zone when the content is not encrypted.

35. The IC of claim 29, wherein the content protected hardware is further configured to determine if the content is secure or unsecure by making a determination based on a syntax element indicating if the content is secure or unsecure.

36. The IC of claim 29, further configured to block an input when an input buffer status indicates content protection, a software status indicates content protection is disabled, and a hardware status indicates content protection.

37. The IC of claim 29, further configured to indicate a valid secure transaction when an input buffer status indicates content protection, a software status indicates content protection is enabled, an output buffer status indicates content protection, and a hardware status indicates content protection.

38. The IC of claim 29, further configured to indicate a valid non-secure transaction when an input buffer status indicates no content protection, a software status indicates content protection is disabled, an output buffer status indicates no content protection, and a hardware status indicates no content protection.

39. The IC of claim 29, further configured to indicate an input page fault when an input buffer status indicates no content protection, a software status indicates content protection is enabled, an output buffer status indicates content protection, and a hardware status indicates content protection.

40. A content receiver comprising:
an unsecure processor;
an unsecure memory coupled to the unsecure processor; and
means for receiving content coupled to means for providing a content protection zone, the means for providing the content protection zone including a secure memory, means for determines if the received content is secure or unsecure and means for directing secure content to the secure memory and unsecure content to the unsecure memory.

41. The content receiver of claim 40, wherein the unsecure memory stores unsecure code.

42. The content receiver of claim 41, wherein the unsecure processor comprises a microprocessor processor and the unsecure code comprises open-source code.

43. The content receiver of claim 40, further comprising means for executing secure code stored in the secure memory, means for executing secure code and the secure memory comprising a protected zone.

44. The content receiver of claim 40, further comprising means for stopping the unsecure processor from accessing the secure memory.

45. The content receiver of claim 40, wherein the content comprises audio and video.

46. The content receiver of claim 40, wherein determining if the content is secure or unsecure includes determining if at least a portion of the content is encrypted and wherein content is protected by the content protection zone when the content is not encrypted.

47. The content receiver of claim 40, further comprising means for determining if the content is secure or unsecure based on a syntax element indicating if the content is secure or unsecure.

48. A computer-readable storage medium having stored thereon instructions that, when executed, cause one or more processors of a device to:
receive content at an input coupled to a content protection zone of the device, at least one of the processors of the device including an unsecure processor, the device further including an unsecure memory coupled to the unsecure processor;
determine if the content is secure or unsecure; and
store the content in a secure memory when the content is secure and storing the content in the unsecure memory when the content is unsecure.

49. The computer-readable storage medium of claim 48, wherein the instructions are further configured to cause the unsecure memory to store unsecure code.

50. The computer-readable storage medium of claim 48, wherein the instructions are configured to cause the device to receive content comprising audio and video.

51. The computer-readable storage medium of claim 48, wherein an instruction causes the device to determine if the content is secure or unsecure based on a determination that at least a portion of the content is encrypted and wherein content is protected by the content protection zone when the content is not encrypted.

52. The computer-readable storage medium of claim 48, wherein an instruction causes the device to determine if the content is secure or unsecure based on a syntax element indicating if the content is secure or unsecure.
